(19) United States
(12) Patent Application Publication
(10) Pub. No.: US 2011/0127970 A1
(43) Pub. Date: Jun. 2, 2011

(54) METHOD OF CHARGING A RECHARGEABLE BATTERY FOR AN ELECTRONIC DEVICE

(76) Inventors: Chuan-Rung Wang, Taipei (TW); Shin-Wei Chen, Taipei (TW); Chia-Han Chan, Taipei (TW)

(21) Appl. No.: 12/628,200

(22) Filed: Nov. 30, 2009

(51) Int. Cl. H02J 7/00

(52) U.S. Cl. 320/150; 320/153

(57) ABSTRACT

A method for charging a rechargeable battery set includes steps of obtaining a temperature of the rechargeable battery set, controlling a charging unit to provide a lower charging energy to the rechargeable battery set if the temperature of the rechargeable battery set exceeding a temperature threshold, and controlling the charging unit to provide a normal charging energy to the rechargeable battery set if the temperature of the rechargeable battery set being below the temperature threshold. Therefore, the charging speed of the rechargeable battery set is decelerated and the rechargeable battery set is maintained in an un-full condition in the condition of high temperature and high remainder capacity for preventing the rechargeable battery set from deterioration to extend it's life.

### BACKGROUND OF THE INVENTION

1. Field of the Invention

The present invention relates to a method of charging a rechargeable battery set, more specifically, to a method for charging a rechargeable battery set of an electronic device to prevent the rechargeable battery from deterioration.

2. The Related Art

Nowadays, electronic devices, such as laptop computers, mobile phones, PDAs, become more compact for saving space and conveniently hand carry. In order to improve mobility, the electronic devices equip a rechargeable battery.

Please refer to FIG. 1 showing a block diagram of the laptop computer 1. The laptop computer 1 has a main body 2, a rechargeable battery set 4 and a power adapter 6. Specially, the rechargeable battery set 4 is a lithium battery. The power adapter 6 is an AC adapter. The main body 2 has a processor unit 8, an input unit 10, an output unit 12, a power converter unit 14 and a charging unit 16. Specially, the power converter unit 14 is a DC/DC converter having a first converting section 18 and a second converting section 20.

The main body 2 connects to the rechargeable battery set 4 and the power adapter 6. The power adapter 6 transfers AC power into DC power and then supplies DC power to the charging unit 16. The charging unit 16 converts DC power into a charging power for charging the rechargeable battery set 4.

The rechargeable battery set 4 supplies a discharging power to the first converting section 18 of the power converter unit 14. The first converting section 18 converts the discharging power into an available power and then supplies the available power to the processor unit 8, the input unit 10 and the output unit 12 respectively. Specially, the first converting section 18 is a step down circuit. The input unit 10 can be a keyboard, a mouse, a touch pad, a microphone, etc. The output unit can be a display screen, a speaker, etc. The processor unit 8 can be a keyboard controller (KBC), a programmable chip, etc.

The second converting section 20 converts DC power received from the power adapter 6 into the available power and then supplies the available power to the processor unit 8, the input unit 10 and the output unit 12 respectively. Specially, the second converting section 20 is a step down circuit.

Please refer to FIG. 2 showing a conventional method for managing the rechargeable battery set 4 of the laptop computer 1. The method includes:
Step 901: The laptop computer 1 is booted.
Step 902: The processor unit 8 judges whether the main body 2 connects to an outlet through the power adapter 6. If the main body 2 connects to the outlet through the power adapter 6, then the step 903 will be executed, else the step 907 will be executed.
Step 903: The processor unit 8 determines that the laptop computer 1 receives power through which one of the following device: the outlet, the power adapter 6 and the section converting section 20.
Step 904: The processor unit 8 judges whether the capacity of the rechargeable battery set 4 is full. If the capacity of the rechargeable battery set 4 is full, then step 905 will be executed, else step 906 will be executed.
Step 905: The processor unit 8 controls the charging unit 16 to stop supplying the charging power to the rechargeable battery set 4. Then step 902 will be repeated.
Step 906: The processor unit 8 controls the charging unit 16 to supply the charging power to the rechargeable battery set 4. The step 904 will be repeated.
Step 907: The processor controls the first converting section 18 to supply the available power to the laptop computer 1, which is discharged by the rechargeable battery set 4 and then converted by the first converting section 18.
Step 908: The processor unit 8 judges whether the capacity of the rechargeable battery set 4 is below a threshold. If the capacity of the rechargeable battery set 4 is below the threshold, then step 909 will be executed, else step 907 will be repeated.
Step 909: The processor unit 8 sends a signal to indicate the capacity of the rechargeable battery set 4 is too low and the effect the laptop computer 1 to enter a sleep mode. Then repeat the step 901.

However, the temperature of the main body 2 will raise after the laptop computer 1 has been working a long time. The high temperature of the main body 2 passes to the rechargeable battery set 4 and then the temperature of the rechargeable battery set 4 will be also raised. Meanwhile, if the capacity of rechargeable battery set 4 is not full and the main body 2 connects to an outlet through the power adapter 6, the rechargeable battery set 4 will keep charging until it is full. Therefore, the rechargeable battery set 4 is in condition of high temperature and high capacity to cause it to deteriorate rapidly. Hence, the life of the rechargeable battery set 4 will be shortened.

### SUMMARY OF THE INVENTION

An object of the present invention is to provide a method for holding a rechargeable battery set in an appropriate condition for preventing the rechargeable battery set from deterioration.

According to the invention, the method for charging the rechargeable battery set connecting to a electronic device includes steps of obtaining a temperature of the rechargeable battery set; sending a first signal to control a charging unit to provide a lower charging energy to the rechargeable battery set for decelerating the charging speed of the rechargeable battery set and maintaining the rechargeable battery set in an un-full condition if the temperature of the rechargeable battery set exceeds a temperature threshold; and sending a second signal to control the charging unit to provide a normal charging energy to the rechargeable battery set if the temperature of the rechargeable battery set being below the temperature threshold.

According to the invention, the method for controlling a charging unit to charge the rechargeable battery set connecting to an electronic device includes steps of storing a characteristic table in said electronic device, said characteristic table having a plurality of temperature threshold segments and a plurality of charging energy levels, each segment corresponding to each level uniquely; obtaining a temperature of the rechargeable battery set by a processor unit of said electronic device; and comparing the temperature of the rechargeable set and temperature threshold segments in the characteristic table to select one of the charging energy levels corresponding to one of the temperature threshold segments matching with the temperature of the rechargeable set and then controlling said charging unit to provide the selected charging energy level to charge the rechargeable battery set in order to decelerate the charging speed of the rechargeable battery set and maintain the rechargeable battery set in an un-full condition if the temperature of the rechargeable battery set exceeds a lowest temperature threshold segment in the characteristic table.

According to the invention, the method for controlling a charging unit to charge a rechargeable battery set connecting to an electronic device includes steps of obtaining a temperature of the rechargeable battery set by a processor unit of said electronic device; calculating a lower charging energy and then controlling the charging unit to provide the lower charging energy to the rechargeable battery set for decelerating the charging speed of the rechargeable battery set and maintaining the rechargeable battery set in an un-full condition if the temperature of the rechargeable battery set exceeds a temperature threshold; and controlling the charging unit to provide a normal charging energy to the rechargeable battery set if the temperature of the rechargeable battery set being below the temperature threshold.

The temperature threshold is the lowest in a temperature range, the temperature range is segmented into a plurality of segments, each segment has a predetermined decrement of the charging energy, the processor unit obtains the lower charging energy by calculating the temperature of the rechargeable battery, the range of each segment, the decrement of the charging energy, and the temperature threshold.

Therefore, the charging speed of the rechargeable battery set is controlled to be slowdown, and the remainder capacity of the rechargeable battery set is controlled in an un-full condition until the temperature of the rechargeable battery set is below the temperature threshold to prevent the rechargeable battery set from the condition of high temperature and high remainder capacity. The rechargeable battery set can be prevented from deterioration for extending its life.

### BRIEF DESCRIPTION OF THE DRAWINGS

The present invention will be apparent to those skilled in the art by reading the following description of preferred embodiments thereof, with reference to the attached drawings, in which:

FIG. 1 shows a block diagram of a laptop computer according to the present invention;

FIG. 2 shows a flow chart of a conventional method for managing a rechargeable battery set of the laptop computer;

FIG. 3 shows a flow chart of a first preferred method for charging the rechargeable battery set according to the present invention;

FIG. 4 shows a flow chart of a second preferred method for charging the rechargeable battery set according to the present invention; and

FIG. 5 shows a characteristic table of comparison between temperature threshold and charging energy according to the present invention.

### DETAILED DESCRIPTION OF THE PREFERRED EMBODIMENT

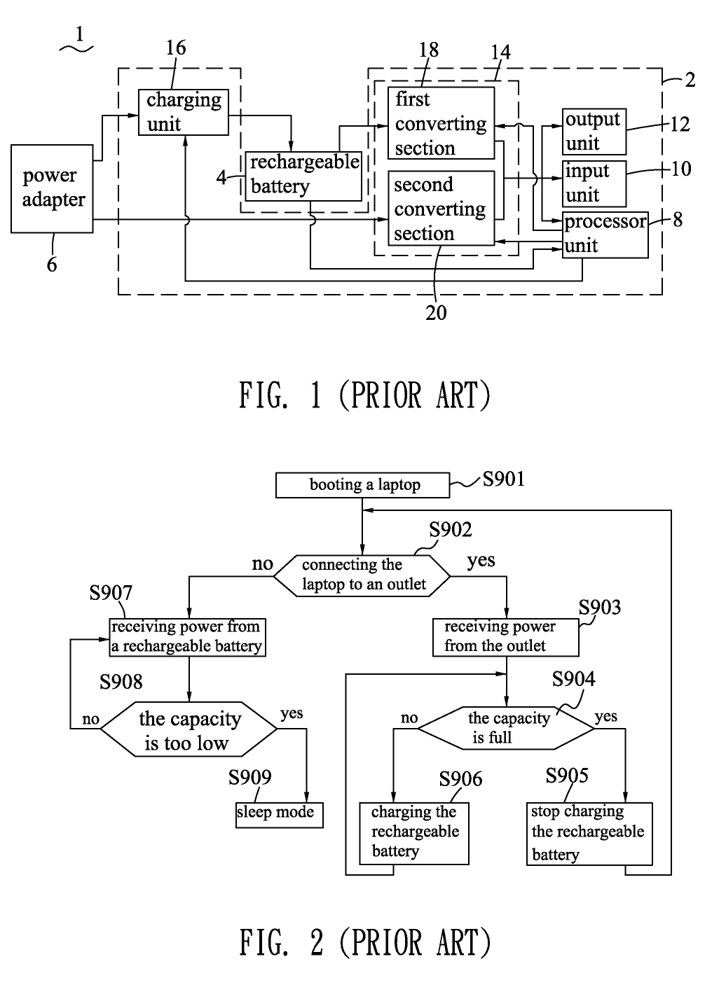

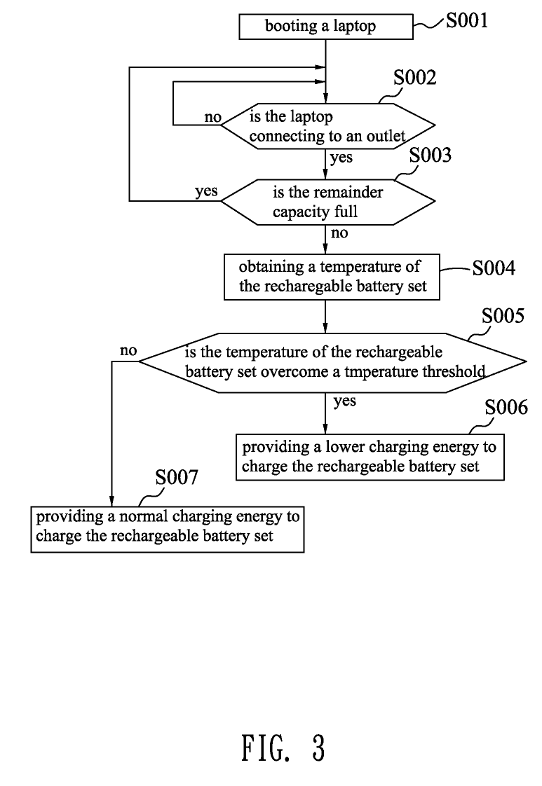

Please refer to FIG. 1 and FIG. 3. FIG. 3 shows a first preferred embodiment of a method for charging a rechargeable battery set. The method can apply to various electronic devices, such as laptop computers, PDAs, mobile phones, etc. In this embodiment, the method applies to the laptop 1 (shown in FIG. 1), which has following steps.

In step S001, the laptop 1 is booted. In step S002, the processor unit 8 judges whether the main body 2 connects to an outlet through the power adapter 6. If the main body 2 connects to the outlet through the power adapter 6, then step S003 will be executed, else step S002 will be repeated. In step S003, the processor unit 8 judges whether the reminder capacity of the rechargeable battery set 4 is full. If the remainder capacity of the rechargeable battery set 4 is full, then step S002 will be repeated, else, step S004 will be executed.

In step S004, the processor unit 8 detects and obtains a temperature of the rechargeable battery set 4. In step S005, the processor unit 8 judges whether the temperature of the rechargeable set 4 exceeds a temperature threshold. If the temperature of the rechargeable battery set 4 exceeds the temperature threshold, then step S006 will be executed, else, step S007 will be executed.

In step S006, the processor unit 8 sends a first signal to control the charging unit 16 to provide a lower energy to charge the rechargeable battery set 4, and then step S002 will be repeated. In step S007, the processor unit 8 sends a second signal to control the charging unit to provide a normal energy to charge the rechargeable battery set 4, and then step S002 will be repeated. For instance, the normal energy can provide 16.8 voltage and 5 ampere, and the lower energy can provide 15.6 voltage and 2 ampere.

Hence, the processor unit 8 send the first signal to control the charging unit 16 to provide lower energy to charge the rechargeable battery set 4, if the processor unit 8 detects the temperature of the rechargeable battery set 4 exceeds the temperature threshold. Therefore, the charging speed of the rechargeable battery set 4 is controlled to be slowdown, and the remainder capacity of the rechargeable battery set is controlled in an un-full condition until the temperature of the rechargeable battery set 4 is below the temperature threshold. Specially, step S003 and step S005 can be exchanged.

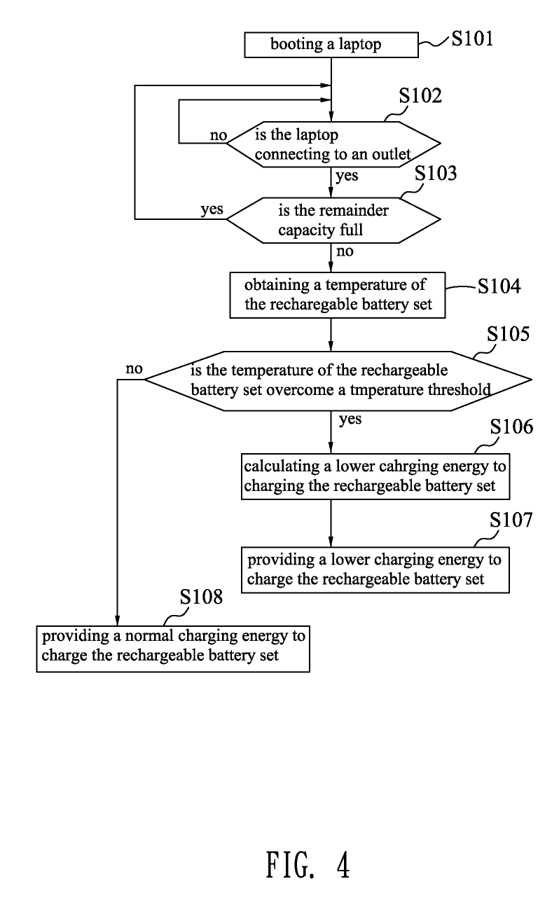

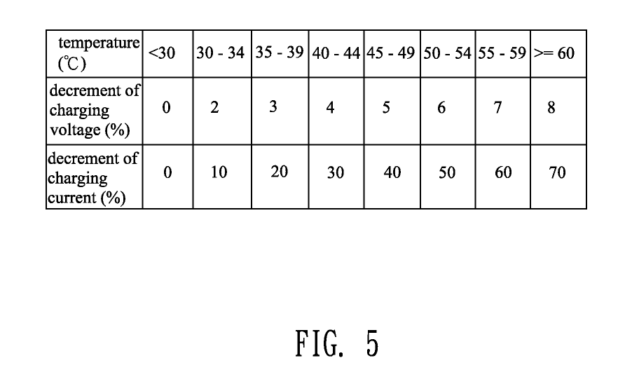

Please refer to FIG. 4 and FIG. 5. FIG. 4 shows a second preferred embodiment of a method for charging the rechargeable battery set 4. FIG. 5 shows a characteristic table of comparison between the temperature thresholds and charging energy.

The temperature threshold is segmented into a plurality of segments corresponding to various charging energies by a predetermined interval. Specially, the temperature threshold is segmented into 8 segments, and the range of each segment is 5 degrees centigrade. Specially, the processor unit has a memory for storing the characteristic table. Furthermore, the characteristic table can be stored in another memory configured in the laptop 1.

In step S101, the laptop 1 is booted. In step S102, the processor unit 8 judges whether the main body 2 connects to an outlet through the power adapter 6. If the main body 2 connects to the outlet through the power adapter 6, then step 103 will be executed, else step 102 will be repeated. In step S103, the processor unit 8 judges whether the remainder capacity of the rechargeable battery set 4 is full. If the remainder capacity of the rechargeable battery set 4 is full, then step S102 will be repeated, else, step 104 will be executed.

In step S104, the processor unit 8 detects and obtains a temperature of the rechargeable battery set 4. In step S105, the processor unit 8 judges whether the temperature of the rechargeable set 4 exceeds a temperature threshold. If the temperature of the rechargeable battery set 4 exceeds the temperature threshold, then step S106 will be executed, else, step S108 will be executed.

In step S106, the processor unit 8 searches the characteristic table based on the temperature of the rechargeable battery set 4 to obtain a charging energy value. For instance, the processor unit 8 detects and obtains the temperature of the rechargeable set 4 being 37 degrees centigrade, and then the processor unit 8 searches the characteristic table based on 37 degrees centigrade to obtains the decrement of the charging voltage is 3 percentages and the decrement of the charging current is 20 percentages.

In step S107, the processor unit 8 sends the first signal to control the charging unit 16 to provide the lower energy, such as 16.3 voltage and 4 ampere, to charge the rechargeable battery set 4, and then step S102 will be repeated. In step S108, the processor unit 8 sends the second signal to control the charging unit 16 to provide the normal energy, such as 15.6 voltage and 2 ampere, to charge the rechargeable battery set 4, and then step S102 will be repeated.

Specially, the processor unit 8 can obtains the charging energy value by calculating formulas mentioned hereafter. The characteristic table can be represented as the following formulas:

V=Vb×(1−Vx);

I=Vb×(1−Vx);

wherein, parameter V represents the calculated charging voltage, parameter I represents the calculated charging current, parameter Vb represents the normal charging voltage, parameter Ib represents normal charging current, parameter Vx represents the decrement of the charging voltage, and Ix represents the decrement of the charging current.

The parameter Vx and the parameter Ix can be represented as the following formulas:

Vx=(Tt−Tb/Ts)×Vrv+Vrb;

Ix=(Tt−Tb/Ts)×Trv+Irb;

wherein, parameter Tt represents the temperature of the rechargeable battery set, parameter Tb represents base temperature, parameter Ts represents the predetermined interval, parameter Vrv represents the difference of decrement voltage between neighbor segments, Irv represents the difference of decrement current between neighbor segments, parameter Vrb represents base decrement voltage, and parameter Irb represents base decrement current.

If the parameter Tt is 37 degrees centigrade, then the corresponding parameters will be that the parameter Tb is 30 degrees centigrade, the parameter Ts is 5, the parameter Vrv is 1 percentage, the parameter Vrb is 2 percentages, the decrement of the charging voltage Vx is 3 percentages and the decrement of the charging current Ix is 20 percentages. If the parameter Vb is 16.8 voltage, then the corresponding parameters will be that the parameter Ib is 5 ampere, the calculated charging voltage V is 16.3 voltage, and the calculated charging current I is 4 ampere.

Specially, the processor unit has a memory for storing the characteristic table. Furthermore, the characteristic table can be stored in another memory configured in the laptop 1. The charging method can be programmed in processor unit 8. The charging method also can be programmed in the memory and the processor unit 8 can acquire the program from the memory and then execute the program.

Specially, the processor unit 8 can judge whether the temperature of the rechargeable battery set 4 exceeds the base temperature. If the temperature of the rechargeable battery set 4 exceeds the base temperature, then the processor unit 8 calculates the above mentioned formulas, else the processor unit 8 sends the second signal to control the charging unit 16 to provide the normal energy.

Specially, the characteristic table may be calculated according to experience. The table may be calculated according to temperature curved of the rechargeable battery 4. Therefore, each kind of rechargeable batteries has itself temperature curved and characteristic table.

If the remainder capacity of the rechargeable 4 is high, the temperature of the rechargeable battery set 4 should be set to low for preventing the rechargeable battery set 4 from deterioration. That is to say, if the temperature of the rechargeable battery set 4 is raised, the remainder capacity of the rechargeable battery set 4 should be decreased.

As described above, if the temperature of the rechargeable battery set 4 exceeds the temperature threshold, the processor unit 8 send a first signal to control the charging unit 16 to provide lower charging energy to charge the rechargeable battery set 4. Since, the charging speed of the rechargeable battery set 4 is controlled to be slowdown, and the remainder capacity of the rechargeable battery set 4 is controlled in an un-full condition until the temperature of the rechargeable battery set 4 is below the temperature threshold to prevent the rechargeable battery set 4 from the condition of high temperature and high remainder capacity. The rechargeable battery set 4 can be prevented from deterioration for extending its life.

Furthermore, the present invention is not limited to the embodiments described above; diverse additions, alterations and the like may be made within the scope of the present invention by a person skilled in the art. For example, respective embodiments may be appropriately combined.

What is claimed is:

1. A method for charging a rechargeable battery set connecting to an electronic device, comprising:
obtaining a temperature of the rechargeable battery set;
sending a first signal to control a charging unit to provide a lower charging energy to the rechargeable battery set for decelerating the charging speed of the rechargeable battery set and maintaining the rechargeable battery set in an un-full condition if the temperature of the rechargeable battery set exceeding a temperature threshold;
sending a second signal to control the charging unit to provide a normal charging energy to the rechargeable battery set if the temperature of the rechargeable battery set being below the temperature threshold.

2. The method for charging a rechargeable battery set as claimed in claim 1, wherein the temperature threshold is segmented into a plurality of segments, the lower charging energy comprises a plurality of levels, each segment of temperature threshold corresponding to each level of lower charging energy uniquely, if the temperature of the rechargeable battery set is raised, a higher value in the segments corresponding to a lower value in the levels, one of the levels of lower charging energy is selected by searching one of the segments of the temperature threshold, corresponding the selected level, to which the temperature of the rechargeable battery set is matched.

3. A method for controlling a charging unit to charge a rechargeable battery set connecting to an electronic device, comprising:
storing a characteristic table in said electronic device, said characteristic table having a plurality of temperature threshold segments and a plurality of charging energy levels, each segment corresponding to each level uniquely;
obtaining a temperature of the rechargeable battery set by a processor unit of said electronic device;
comparing the temperature of the rechargeable set and temperature threshold segments in the characteristic table to select one of the charging energy levels corresponding to one of the temperature threshold segments matching with the temperature of the rechargeable set and then controlling said charging unit to provide the selected charging energy level to charge the rechargeable battery set in order to decelerate the charging speed of the rechargeable battery set and maintain the rechargeable battery set in an un-full condition if the temperature of the rechargeable battery set exceeding a lowest temperature threshold segment in the characteristic table.

4. The method for controlling a charging unit to charge a rechargeable battery set as claimed in claim 3, wherein the characteristic table is storing in the processor unit.

5. The method for controlling a charging unit to charge a rechargeable battery set as claimed in claim 3, wherein the characteristic table is storing in a memory in the electronic device.

6. A method for controlling a charging unit to charge a rechargeable battery set connecting to an electronic device, comprising:
obtaining a temperature of the rechargeable battery set by a processor unit of said electronic device;
calculating a lower charging energy and then controlling the charging unit to provide the lower charging energy to the rechargeable battery set for decelerating the charging speed of the rechargeable battery set and maintaining the rechargeable battery set in an un-full condition if the temperature of the rechargeable battery set exceeding a temperature threshold;
controlling the charging unit to provide a normal charging energy to the rechargeable battery set if the temperature of the rechargeable battery set being below the temperature threshold;
wherein the temperature threshold is the lowest in a temperature range, the temperature range is segmented into a plurality of segments, each segment has a predetermined decrement of the charging energy, the processor unit obtains the lower charging energy by calculating the temperature of the rechargeable battery, the range of each segment, the decrement of the charging energy, and the temperature threshold.

7. The method for controlling a charging unit to charge a rechargeable battery set as claimed in claim 6, wherein the processor unit obtains the lower charging energy by calculating the temperature of the rechargeable battery, the range of each segment, the decrement of the charging energy, and the temperature threshold.
